(19) United States
(12) Patent Application Publication
(10) Pub. No.: US 2020/0113758 A1
(43) Pub. Date: Apr. 16, 2020

(54) WHEELCHAIR FOR CAREGIVERS

(71) Applicant: Irma McNeil, Valdosta, GA (US)

(72) Inventor: Irma McNeil, Valdosta, GA (US)

(21) Appl. No.: 16/577,710

(22) Filed: Sep. 20, 2019

Related U.S. Application Data
(60) Provisional application No. 62/734,075, filed on Sep. 20, 2018.

(51) Int. Cl. A61G 5/12

(52) U.S. Cl. CPC A61G 5/127; A61G 5/1094; A61G 5/122

(57) ABSTRACT

A wheelchair is disclosed that is especially designed for caretakers of severely handicapped patients. The wheelchair is pushed in a seat-backward direction that allows the caretaker to see the patient face-to-face for better evaluation of the patient's comfort status during movement of the wheelchair.

### FIELD OF THE INVENTION

The invention relates to wheelchairs that help caretakers to view the patient face to face to better observe and address discomfort or difficulties by the patient, particularly patients that cannot communicate well or at all.

### BACKGROUND OF THE INVENTION

Traditionally, wheelchairs have been designed for patients to propel themselves forward with rails on the wheels or for caretakers to grasp handles on the rear of the chair and push the patient in a face-forward direction. This arrangement does not, however, work well for patients who are handicapped to the point of immobility and noncommunication. Such patients may not be able to tell their caregiver that they are suffering discomfort during a walk outdoors, e.g., the trachea tube has an accumulation of insects or other obstructions that need to be wiped away, the sun is too harsh, etc.

It would be desirable to have a wheelchair designed for caregivers that would allow the caregiver to view the patient face-to-face while the chair is in motion so that the caregiver can better evaluate the condition of the patient at a glance.

It would also be desirable to have a wheelchair designed for caregivers that would allow the supporting seat and back to be reclined for greater patient comfort while in the chair.

### SUMMARY OF THE INVENTION

It is an object of the invention to provide a wheelchair that has been designed for the caregiver.

It is also an object to provide a wheelchair designed for caregivers of severely handicapped patients with compromised movement and communication abilities.

### BRIEF DESCRIPTION OF THE DRAWINGS

FIG. 1 shows a wheelchair according to the invention.

### DETAILED DESCRIPTION

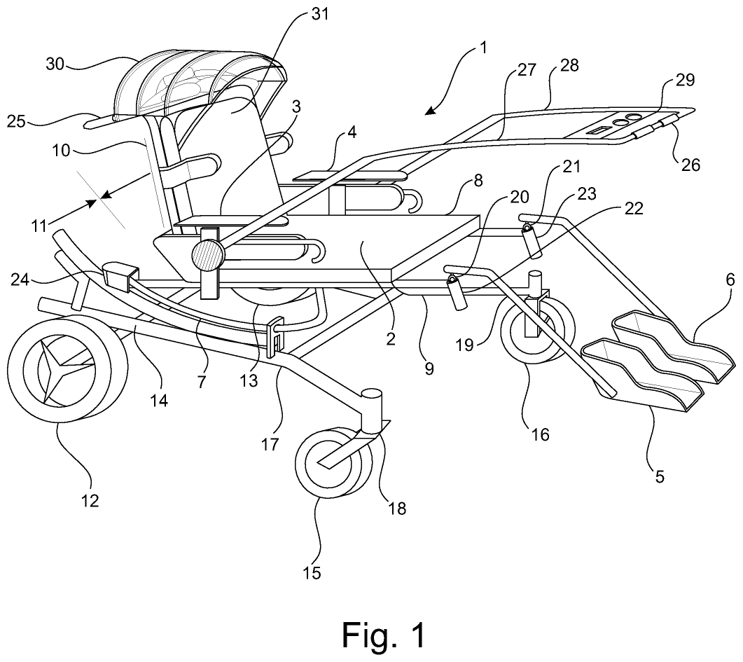

As shown in FIG. 1, wheelchair 1 includes a seat 2 and armrests 3, 4 as well as foot supports 5, 6 to accommodate the patient (not shown). A pair of curved, lateral guide rails 7, 8 allow the seating compartment 9 to be tilted from an upright position 10 by sliding guides 24 along rails 7, 8 to a reclining position 11. Rear wheels 12, 13 are connected by a fixed axle 14. Front wheels 15, 16 are each associated with frame 17 via spring-biased spindles 18, 19. Foot supports 5, 6 are connected to frame 17 with posts 20, 21 inserted into sockets 22, 23 and may be removed to facilitate entry and exit of the patient from wheelchair 1.

Wheelchair 1 has two sets of handles that are suitable for pushing the wheelchair. Traditional rear handles 25 allow the caregiver to push the chair with the patient sitting in a forward-facing position in which wheels 15, 16 lead the direction of travel.

Detachable front handle 26 extends over foot supports 5, 6 with arms 27, 28 connected to frame 17 under armrests 3, 4. Preferably, arms 26, 27 are concentric tubes that can be extended and secured in position with a transverse pin or spring-biased détente. Pushing front handles 26 allow the patient to be moved in a rear-facing direction (rear wheels 12, 13 lead the direction of travel) and permits the caregiver to monitor the status of the patient face to face—a particular advantage with patients who may not be able to communicate. Caregivers can thus better monitor their patient for signs of stress or discomfort during an outing while also having the ability to drive the chair up and down curbs like a traditional wheelchair. Optional front tray 29 provides compartments for medications, a cell phone, and similar items relevant to the caregiver and/or patient.

Top shade 30 can be attached to frame 17 on either side of back support 31 of seat 2. Shade 30 extends to the front and rear of back support 31 to provide protection for the patient sitting in seat 2.

1. A wheelchair designed for caregivers that comprises:
a. (a) a wheelchair frame supporting a seat, a backrest, and a pair of foot supports, said frame being connected to two front and two rear wheels, and having a pair of grippable handles at the rear of said frame that allow the wheelchair to be pushed in a seat-forward direction; and
b. (b) a removable, transverse, gripping section extending across the width of said frame and having arms that extend away from the backrest, over said foot supports and said seat to connections on opposite sides of said frame, whereby pushing on said gripping section exerts force on said frame and allows said wheelchair to be pushed in a seat-backward direction.

2. A wheelchair according to claim 1 further comprising a shade cover vertically over said backrest and over at least a portion of said seat.

3. A wheelchair according to claim 1 wherein said seat is pivotably connected to said backrest and further comprising a curved guiderail and sliding guides along said guiderail, said sliding guides being connected to an undercarriage of said seat and allowing said seat to be moved in forward and backward directions and thereby recline said backrest when said guides are moved to a forward position along said guiderails.
